(19) United States
(12) Patent Application Publication
(10) Pub. No.: US 2016/0314596 A1
(43) Pub. Date: Oct. 27, 2016

(54) CAMERA VIEW PRESENTATION METHOD AND SYSTEM

(71) Applicant: Hai Yu, Canton, MI (US)

(72) Inventor: Hai Yu, Canton, MI (US)

(21) Appl. No.: 14/696,476

(22) Filed: Apr. 26, 2015

(51) Int. Cl. G06T 7/20; G06T 7/00; H04N 5/247

(52) U.S. Cl. CPC G06T 7/2093; H04N 5/247; G06T 7/004; G06T 2207/30196; G06T 2207/10016; G06T 2207/30241

(57) ABSTRACT

The method and system for providing automatic camera view presentation over a target object using multiple static and/or limit orientation cameras over an activity filed. A specified target object in the activity field is tracked among the camera view frames continuously. The invented method and system first process received camera view frames to recognize the target object in them. The position and motion of the target object are then estimated. Based on prescribed presentation criteria, candidate camera view frames are ranked with presentation scores. In an exemplary application, a view frame with a higher presentation score shows the target object at a closer position to its frame center and in a higher image resolution. After that, final presentation view frames are selected from the top ranked candidate view frames. The final view frames are used for presenting the target object on displaying devices for automatic target object exhibition.

### TECHNICAL FIELD

The present invention is in the field of automatic camera view controls, pertains more particularly to systems and methods for providing quality focused camera view over moving objects in sport, performance and presentation activities. The invented automatic camera viewing system aims at supporting performance recording and assessment for high quality self-training, remote-training, and video sharing purposes using a groups of static and/or limit orientation camera systems.

### BACKGROUND

In sports and performances, it is highly desirable to have a way to help people reviewing their performance with sufficiently focused details in order to improve their skills during training exercises and exhibitions. Camera systems are more and more intensively involved in such training and exhibition systems. The cameras produce video streams that can be displayed to users. Both trainees and their coaches can review the recorded performance and exhibition in real time or afterwards to find out the insufficiency in the trainee's skill and performance. However, traditional camera recording processes usually need a professional cameraman to manually operate the orientation and zoom of the camera in order to have a performer presented in the camera view with sufficient focuses on motion details. Such assistant services are hardly available or affordable for common exerciser and nonprofessional players on a regular basis.

Professional coaches can only provide training in a limited region and time schedule. People live in a farther region are expecting to have a way to get their specialized coaching remotely. The availability of a public accessible camera viewing and reviewing service will be able to help them realize their self-training and remote-training dreams in a most effective and cost-efficient way. Their performances can be recorded with sufficient details and they can be reviewed by their favorite coaches without requiring them onsite at the same training schedule.

In order to provide the desired services, this invention discloses camera view presentation control method and system that can provide highly focused camera view to track user specified objects automatically. Such a high quality service has not been available in common public sport or activity places. Existing auto-focusing camera systems are incapable to follow the dynamic motions of a performer while capturing sufficient details of the performance.

The invented automatic camera viewing system integrates camera systems, displaying devices, communication networks, and computerized control systems. It is able to provide automatic object viewing applications including: fast initial target object locating; target object specification from displaying devices; automatic and focused object following and viewing controls; video recording and sharing; etc. The invented automatic camera viewing system provides services at public activity places. Users can access the service from their mobile device, like smartphones, and select desired target object to follow in camera view. Users can view and review recorded performance on their mobile devices or from any network connected computer and mobile devices, like desktop/laptop computer, tablet computer, smartphone, stadium large screen, etc.

The invented camera viewing system aims at supporting performance recording and assessment in activities like sports, performances and exhibitions. It provides a high quality auto-focus and auto-following camera viewing solution to satisfy training, performance assessment and entertainment needs in activities.

### SUMMARY OF THE INVENTION

The following summary provides an overview of various aspects of exemplary implementations of the invention. This summary is not intended to provide an exhaustive description of all of the important aspects of the invention, or to define the scope of the inventions. Rather, this summary is intended to serve as an introduction to the following description of illustrative embodiments.

Illustrative embodiments of the present invention are directed to a method, a system, and a computer readable medium encoded with instructions for automatically controlling the presentation of camera view frames for performance viewing and video recording applications.

In a preferred embodiment of this invention, video streams are captured from at least one camera system that has either fixed orientation or limited Pan-Tilt (PT) orientation adjustment capability. Each camera system has only a limited Field of Coverage (FoC) in its camera view frame at any specific orientation position and zoom ratio. The camera view FoC defines the area in an activity filed that can be shown in the view frame of a camera system. By continuously locating the position of a target object, an object presentation view can be generated from a subset of the camera view frames that have FoC over the position of the target object. The resulted presentation view optimally centers the target object in the view frame with sufficient image quality. A moving target object is thus captured in the presented camera view continuously. Furthermore, the digital camera zoom is controlled to achieve a preferred object presentation ratio between the image size of the target object and the size of the camera view frame presented to users.

The invention disclosed and claimed herein comprises tracking and positioning a target object in received camera view frames. First, camera view frames are obtained from multiple video streams transferred from at least one camera system. Based on the latest determined position of a target object, camera frames that have their view potentially covering the target object are selected as candidate presentation view frames. Through image processing, the target object is recognized in at least one of the candidate presentation view frames such that the present position of the target object can be determined based on the identified pixel position of the target object in the view frame. Next, target object presentation score is evaluated for the candidate presentation view frames using prescribed object presentation criteria. The top ranked candidate presentation view frames are then selected as the final presentation view frames to generate the object presentation view for displaying.

The invention disclosed and claimed may further comprises a method for determining the state parameters of the target object such that the evaluation of the target object presentation score is further based on the determined state parameters. Exemplary state parameters of the target object comprises but not limited to: the present motion parameters, the present orientation parameters, the estimated future position and the estimated future motion and orientation parameters.

In some embodiments of the present invention, the measurement of object's position is obtained using vision based positioning methods. In some other embodiments of the present invention, WiFi based positioning methods are used to assist object positioning. In some other embodiments, the measurement of target object's position is obtained from other positioning methods using cellular network and/or navigation satellites. In some embodiments of the present invention, the target object position has coordinates in a defined camera view coordinate system that can be mapped to each of the camera view frames. In some other embodiments, the target object position has coordinates in a locally defined field coordinate system.

In some embodiments of the present invention, the candidate camera view frames are ranked based on their evaluated target object presentation scores. The evaluation of the target object presentation score comprises a mixture of criteria. Exemplary criteria include but not limited to: minimal distance from the position of the target object in camera frame to the camera frame center position; maximal ratio between the size of the target object presented on the camera frame to the frame size; minimal error between the orientation of the target object in camera frame to a reference orientation; minimal target object occlusion; and minimal potential switches projected in a future time horizon that is needed to best exhibit the target object.

In some embodiments of the present invention, the candidate camera frame that has the highest target presentation score is delivered for displaying. In some other embodiments, a number of top ranked candidate camera frames are delivered and arranged for object presentation show. In yet some embodiments, the final displayed view frame is an object presentation view that is generated from highest ranked candidate camera frame or the top ranked candidate camera frames using methods comprising but not limited to: digital zooming method, 2D or 3D view construction methods.

Illustrative embodiments of the present invention are directed to method and system for automatic object-following camera view control. Exemplary embodiments of the invention comprise at least one camera system; at least one displaying device; and a computer based view presentation control center. Additional features and advantages of the invention will be made apparent from the following detailed description of illustrative embodiments.

### BRIEF DESCRIPTION OF THE DRAWINGS

FIG. 1 is a schematic diagram of a camera view presentation system that provides automatic and object-focused camera view control according to one or more embodiments;

FIG. 2 is a flowchart illustrating an exemplary service process of the automatic and object-focused camera viewing control system according to one or more embodiments;

FIG. 3 is a flowchart illustrating a method for preparing candidate presentation view frames according to one or more embodiments;

FIG. 4 is a flowchart illustrating a method for target object recognition based position and orientation determination according to one or more embodiments;

FIG. 5 is a flowchart illustrating a method for target object position and motion estimation according to one or more embodiments;

FIG. 6 is a flowchart illustrating a method for object presentation view generation according to one or more embodiments;

FIG. 7 is a flowchart illustrating a method for controlling object view displaying according to one or more embodiments.

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present invention discloses methods and systems for an automatic camera viewing system that provides high quality focused camera view over moving objects in sport, performance and entertainment activities. The invented system automatically recognizes a specified target objects camera view frames that take view image over an activity field. The camera view frames that best present the target object are selected for generating displaying object view. The invented system comprises at least one camera system that either has fixed orientation or has limited adjustable orientation. Each of the camera system generates at least one view frame. Each view frame has a specific view coverage over the activity filed called Field of Coverage (FoC). Area inside FoC in the activity field is shown in the camera view frame image. Due to limited view coverage capability, one camera view frame is not able to cover the full activity filed in its view, or it can cover the full activity filed but in insufficient image resolution. To solve this problem, a coordinated view presentation scheme is needed in order to track and focus a target object in at least one of the camera view frames while the target object is moving anywhere in the activity.

By identifying the object position and its corresponding pixel position in camera view frames, the best camera view frames that have the target object showing in them are found and they will be used to generate the final object displaying view frame on displaying devices. Even though each of the view frames has only a limited FoC over an activity field, by coordinate all the available camera view frames, the final presented camera view is able to continuously track and focus on the target object in motion over the full activity field across camera views. The object recognition and positioning provide the key technologies to support camera view frame selection and object view frame generation such that high quality and continuous object following view is realized.

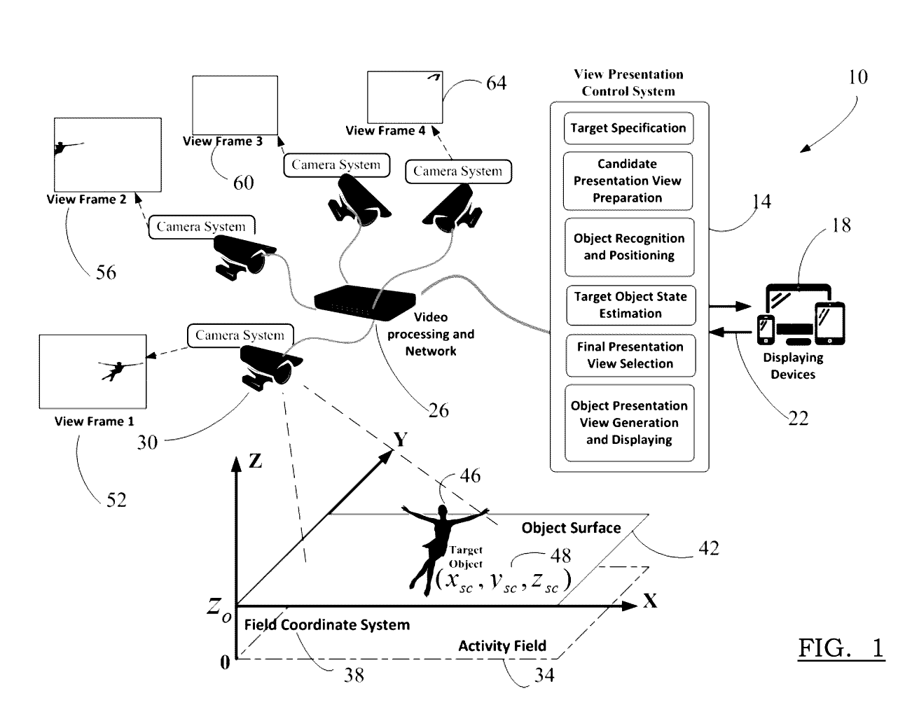

With reference to FIG. 1, a service system that provides automatic and object-focused camera view control is illustrated in accordance with one or more embodiments and is generally referenced by numeral 10. The service system 10 comprises at least one camera system 30 for capturing view streams, a camera video processing and network unit 26, a view presentation control system 14, at least one displaying device 18, and a communication network with an exemplary channel 22. The communication network connects all the devices in the service system for data and instruction communications. Primary embodiments of the communication network are realized by the WiFi network and Ethernet cable connections. Alternative embodiments of such communication channels comprise wired communication networks (Internet, Intranet, telephone network, controller area network, Local Interconnect Network, etc.) and wireless networks (mobile network, cellular network, Bluetooth, etc.). Extensions of the service system also comprise other internet based devices and services for storing and sharing recorded camera view videos.

In an activity field 34, a target object is illustrated by a person 46. The presented view generated from a group of the camera systems 30 can follow and focus on the target object 46. A field coordinate system (FCS) 38 is defined over the activity field 34. Exemplary embodiment of the FCS is a three dimension Cartesian coordinate system where three perpendicular planes, X-Y, X-Z and Y-Z, are defined in the activity space. The three coordinates of any location are the signed distances to each of the planes. In the FCS 38, an object surface 42 at the height of zₒ defines the base activity plane for tracking moving objects 46. The object surface 42 can be in any orientation angle with respect to the 3D planes of FCS 38. In the present embodiment, it is illustrated as a plane that is parallel to the X-Y plane. The position of the target object 46 in the FCS 38 is defined by coordinates (x_{sc}, y_{sc}, z_{sc}) 48. In some other embodiment, the object surface 42 can be a vertical plane that is perpendicular to X-Y plane.

In some other embodiments of the invention, a virtually defined coordinate system (VCS) is used rather than FCS 38. Exemplary embodiment of VCS is a coordinate system defined based on a frame coordinate system defined for one of the camera systems. There are consistent mapping relationships to transfer any pixel position in any of the camera frames to the VCS. In other words, the VCS is actually equivalent to the function of the FCS 38 with only definition difference. Without loss of generality, the following presentation uses FCS 38 to illustrate the invented art.

The position of the target object 46 in FCS 38 is determined by an object recognition and positioning function inside the view presentation control system 14. The location of object 46 is computed based on measurement data related to its position in FCS 38 using vision based positioning method. In a vision based positioning method, the position of an object in FCS 38 is determined based on the identified pixel position of the object in a camera view frame together with the spatial relationship between position in the camera frame's pixel coordinate and the position in FCS 38. In some embodiments of the invented system, a WiFi based positioning method is used to assist target object positioning. The position of an object in FCS 38 is determined when the object is attached with a device that reads and reports the signal strength indicator (RSSI) of WiFi access points. Based on the obtained RSSI data, the position of the object can be determined from a pre-calibrated RSSI fingerprinting map over the activity field 34.

The position of the object in FCS 38 may be determined using a variety of methodologies. Non-limiting examples of suitable methodologies for vision based positioning method and apparatus and WiFi based positioning method and apparatus are described in United States Patent Application Publication No. 14177772, and United States Patent Application Publication No. 14194764, the disclosures of which are incorporated herein by reference.

The object tracking engine further computes the motion parameters of objects 18 in the activity field 34. Exemplary embodiments of the motion parameters comprise translational velocity and acceleration of the target object 46 in the 3D space of FCS 38. Other embodiments of the motion parameters further comprise rotational velocity and acceleration of the target object 46 around its motion center or center of gravity. In some other embodiments, the orientation (facing direction) of the target object is also identified in the camera view frames. Furthermore, the object recognition and positioning function in the view presentation control system 14 predicts the object's future position and future motion parameters.

A camera system 30 comprises a camera device for capturing view image stream and for transforming the camera view into digital or analog signals. The camera device is either a static camera device or a Pan-Tilt (PT) camera device with limited orientation adjustment capability. A static camera device has fixed orientation. At a certain zooming ratio, the camera view frame has a fixed FoC over the activity field 34. Only objects inside the FoC will be presented in the camera view frame. Other types of static camera devices, like pinhole cameras, can have full FoC over the activity field 34. However, their view frames have strong distortion. A de-wrapped view frame obtained using 3D transformation can only provide a view frame with sufficient view quality but with limited FoC as well. A PT camera device can adjust its orientation to shoot at different areas of the activity field 34. But a PT camera with limited orientation adjustment capability either cannot has its FoC cover the whole activity field 34 due to physical pan and tilt limits or cannot follow a moving object sufficiently due to rotating speed constraints. In other words, the camera device used in the invented system has only limited view coverage capability over the activity field. This makes a coordinated camera view control and object view generation scheme a necessity to provide quality object following view services.

The camera system 30 connects to a video processing and networking unit 26. The video processing and networking unit 26 is a computerized device for configuring camera system 30 and transferring camera view stream to connected devices. It also takes inputs from connected devices to change the states of the camera system 30 and to report the camera system parameters to connected devices. The camera system 30 comprises a camera zoom controller that can change the camera zoom to adjust the FoC the camera view with respect to the activity field 34. Changing the camera zoom also change the relative image size of an object 46 in the camera view. In some embodiments, the zoom controller is a mechanical device that adjusts the optical zoom of the camera device. In some other embodiments, the zoom controller is software based digital zoom device that crop the original camera view down to a centered area with the same aspect ratio as the original camera view.

A displaying device 18 is a computerized device that comprises memory, screen and at least one processor. It is connected to the view presentation control system 14 through the communication network 22. Exemplary embodiments of displaying devices are smartphone, tablet computer, laptop computer, TV set, stadium large screen, etc. After receiving the object view frame data, the displaying device 18 displays the generated object view on its screen. Some exemplary embodiments of the displaying device have input interface to take user's control and selection commands and to communicate data and commands with the view presentation control system 14. For example, a user can arrange multiple object view frames on the screen of the displaying device 18 such that the primary view takes a larger central screen area while the rest view frames take side displaying area. Other examples of data and command communication between the displaying device 18 and the view presentation control system 14 include: instructions that take user inputs to control the pan and tilt motions to change the camera orientation; instructions that take user inputs to change camera zoom and view resolution; instructions to specify target object; instructions that configure service system options; instructions that change service system operations, instructions that setup additional displaying methods and devices; instructions that setup the camera view stream recording option for camera view video reviewing, uploading and sharing methods, etc.

The view presentation control system 14 is a computer device that comprises memory and at least one processor. It is connected to the communication network. The view presentation control system 14 is designed to provide a bunch of system operation functions comprising target specification, candidate presentation view presentation, object recognition and positioning, target object state estimation, final presentation view selection and object presentation view generation and displaying.

A target object can be specified among objects that are recognized in camera view frames. The specification can be achieved either by user inputs or by its position or feature attributes. In a primary embodiment of the invention, a user navigates through camera view frames and finds a view frame that best covers and presents a desired object. Candidate objects are first recognized by the view presentation control system 14 and they are highlighted in each of the received camera view frames. A user can point on any of the candidate object to specify it as the target object. Alternatively, a user can point on multiple objects on the displayed view frame to specify a group type of target object.

After target object specification is finished, the view presentation control system 14 initializes its object recognition and positioning function by taking the initial position of the target object and by learning the features of the target object for object recognition in future camera view frames. When new camera view frames are received, the view presentation control system 14 process at least one camera view frame to recognizes the target object and to computes its position in FCS 38 using primarily vision based positioning method. Meanwhile, new features of the target object are learned to strengthen its object recognition robustness and capability. Based on the computed position of the target object, the view presentation control system 14 is able to estimate the motion of the target object 46 in FCS 38 including its moving velocity, acceleration and orientation. Exemplary embodiments of the motion estimation algorithm can be a Bayesian filter based Kalman filter algorithm or particle filter algorithm. Alternatively, an image pixel motion based Optical flow method can be used. The object tracking engine can further predicts future position and motion of the target object 46 in FCS 38.

The invention disclosed and claimed herein comprises tracking and positioning a target object in received camera view frames. First, camera view frames are obtained from multiple video streams transferred from at least one camera system. Based on the last determined position and/or the estimated position of a target object, camera frames that have their view potentially covering the target object are selected as candidate presentation view frames. Through image processing, the target object is recognized in at least one of the candidate presentation view frames such that the present position of the target object can be determined based on the view frame coordinates of the recognized target object. Next, target object presentation score is evaluated for the candidate presentation view frames using prescribed object presentation criteria. The top ranked candidate presentation view frames are then selected as the final presentation view frames to generate the object presentation view for displaying.

In some embodiments of the present invention, the candidate camera view frames are ranked based on their evaluated target object presentation scores. The evaluation of the target object presentation score comprises a mixture of criteria. Exemplary criteria include but not limited to: minimal distance from the position of the target object in camera frame to the camera frame center position; maximal ratio between the size of the target object presented on the camera frame to the frame size; minimal error between the orientation of the target object in camera frame to a reference orientation; minimal target object occlusion; and minimal potential switches projected in a future time horizon that is needed to best exhibit the target object.

In some embodiments of the present invention, the candidate camera frame that has the highest target presentation score is delivered for displaying. In some other embodiments, a number of top ranked candidate camera frames are delivered and arranged for object presentation show. In yet some embodiments, the final displayed view frame is an object presentation view that is generated from highest ranked candidate camera frame or the top ranked candidate camera frames using methods comprising but not limited to: digital zooming method, 2D or 3D view construction methods.

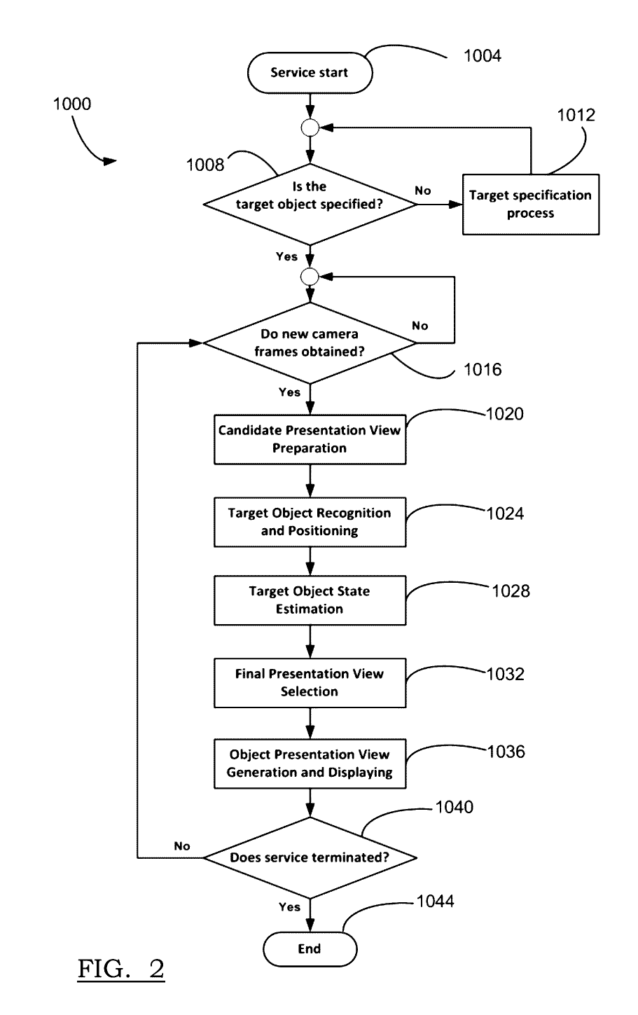

With reference to FIG. 2, a method for providing automatic and object-focused camera viewing service is illustrated according to one or more embodiments and is generally referenced by numeral 1000. After starting at step 1004, this method first checks if the target object is specified at step 1008. The service continues to the subsequent processing procedures until a successful target object specification is achieved at step 1012. Next at step 1016, the method waits for obtaining new camera view frames. Once received, the first processing step is candidate presentation view preparation at 1020. Here candidate presentation view frames are selected from the raw camera view frames that have sufficient view coverage over the determined position of the target object. At step 1024, the target object is recognized in at least one of the candidate presentation view frames to determine the pixel coordinate position of the target object in a corresponding candidate presentation view frame. Based on the coordination relationship between the candidate presentation view frame and the FCS 38, the position of the target object in FCS 38 is thus determined through coordinate transformation. Furthermore, the orientation facing direction of the target object may also be recognized from selected candidate presentation view frames.

When multiple positioning results are available either from more than one candidate presentation frames or from addition object positioning methods, the position of the target object is further filtered through a Bayesian filtering algorithm to estimate the position of the target object in FCS 38 at step 1028. In addition, the motion states of the target object is estimated and the future position and motion states of the target object can be predicted. Based on the estimated orientation, position and motion states of the target object, object presentation scores are evaluated for each of the candidate presentation view frames at step 1032. The higher the score, the better presentation quality the target object is shown in the candidate view frame according to evaluation criteria like facing direction, distance to frame center and object image resolution, etc. A set of top ranked candidate view frames are selected as the final presentation view frames.

Next at step 1036, object presentation view frames are generated from the final presentation view frames for object following view applications. The generation of the object presentation view frames can either be directly copied from a number of top ranked candidate camera frames, or they can be produced from the highest ranked candidate view frame or the top ranked candidate view frames using digital zooming, 2D or 3D view construction methods. The object presentation view frames are then transmitted to the displaying device and they are displayed based on system or user configurations to present the target object following view. The method 1000 next checks if the service is terminated by user at step 1040. If not, the process goes to step 1016 to continue the target tracking procedures. Otherwise, the method 1000 stops at step 1044.

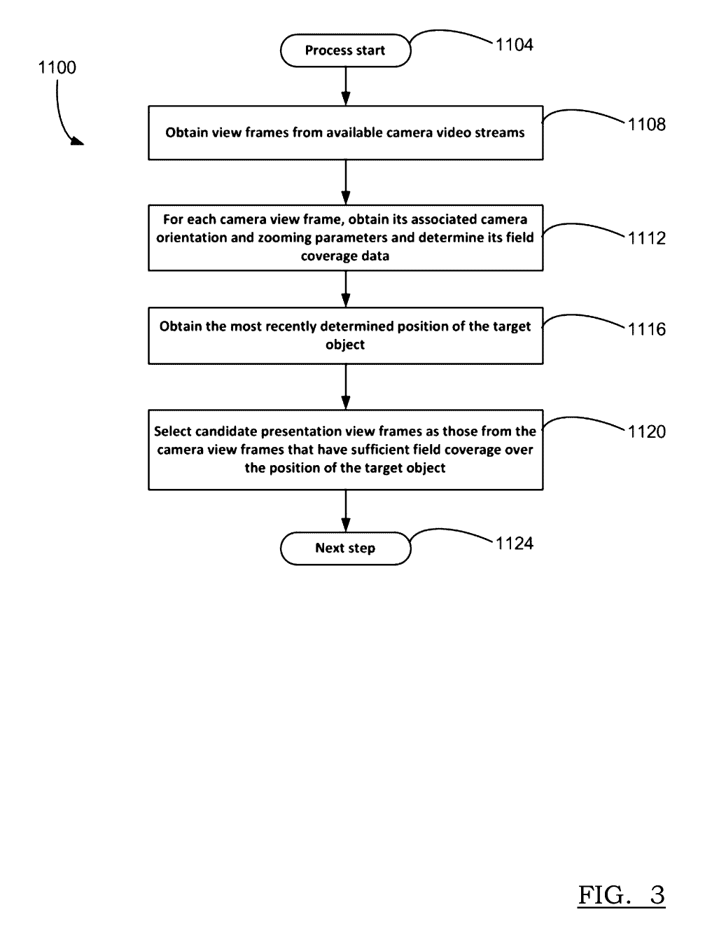

With reference to FIG. 3, a method for preparing candidate presentation view frames is illustrated according to one or more embodiments and is generally referenced by numeral 1100. The method achieves the service function in step 1020 in FIG. 2. After the process starts at 1104, it obtains view frames from available camera video streams at step 1108. Then, for each camera view frame, associated camera orientation and zooming parameters are obtained as well at step 1112. These parameters are either read from system configuration data or from the camera systems 30. Based on these data, view frame FoC is determined. In an exemplary embodiment of the frame FoC, the positions of the four frame corner points in FCS 38 are determined to specify the area in FCS 38 that can be covered and presented in the view frame. Any position in FCS 38 that is inside the polygon defined by the four corner points in FCS 38 is shown in the view frame. Next at step 1116, the most recently determined position of the target object is loaded. The candidate presentation view frames are thus selected at step 1120 as those camera view frames that have sufficient FoC over the position of the target object in FCS 38. A sufficient coverage in most of the case also indicates that the FoC of the camera view frame covers the position of the target object plus an appropriate object sizing region. This method continues to next processing steps at 1124.

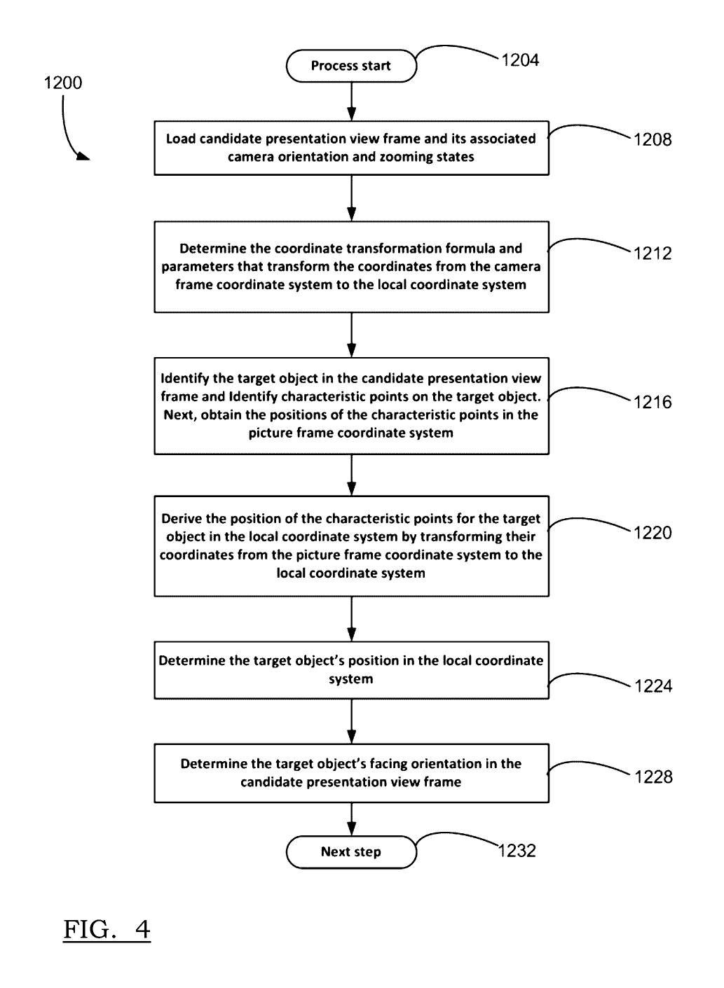

With reference to FIG. 4, a method for target object recognition based position and orientation determination is illustrated according to one or more embodiments and is generally referenced by numeral 1200. After the process starts at step 1204, it first loads candidate presentation view frames and its associated camera orientation and zooming states. At least one of the candidate presentation view frame is used for the object recognition and positioning purpose. The coordinate transformation formula and parameters that transforms the coordinate from the camera frame's pixel coordinate system to the FCS 38 is determined at step 1212 for each of the used candidate presentation view frames. The previously determined position of the target object can now be transformed to its corresponding pixel coordinate position in each of the used candidate presentation view frames as well. Next, for each of the used candidate presentation view frames, the target object is recognized near the determined pixel coordinate position with characteristic points of the target object identified at step 1216. The positions of the characteristic points in the frame's pixel coordinate system are then determined and updated in step 1220. The spatial relationship between the positions in camera view frame coordinate (pixel coordinate) and the FCS 38 is used to map the identified pixel position of the target object to its position in FCS 38. Based on coordinate transformation from the pixel coordinate system to FCS 38, the positions of the characteristic points in FCS 38 are derived. Subsequently at step 1224, the position of the target object in FCS 38 is determined from the positions of its characteristic points. Meanwhile, through face recognition technology, the facing direction of the target object in the candidate presentation view frame can optionally be identified at step 1228. After that, the method continues to other process at step 1232.

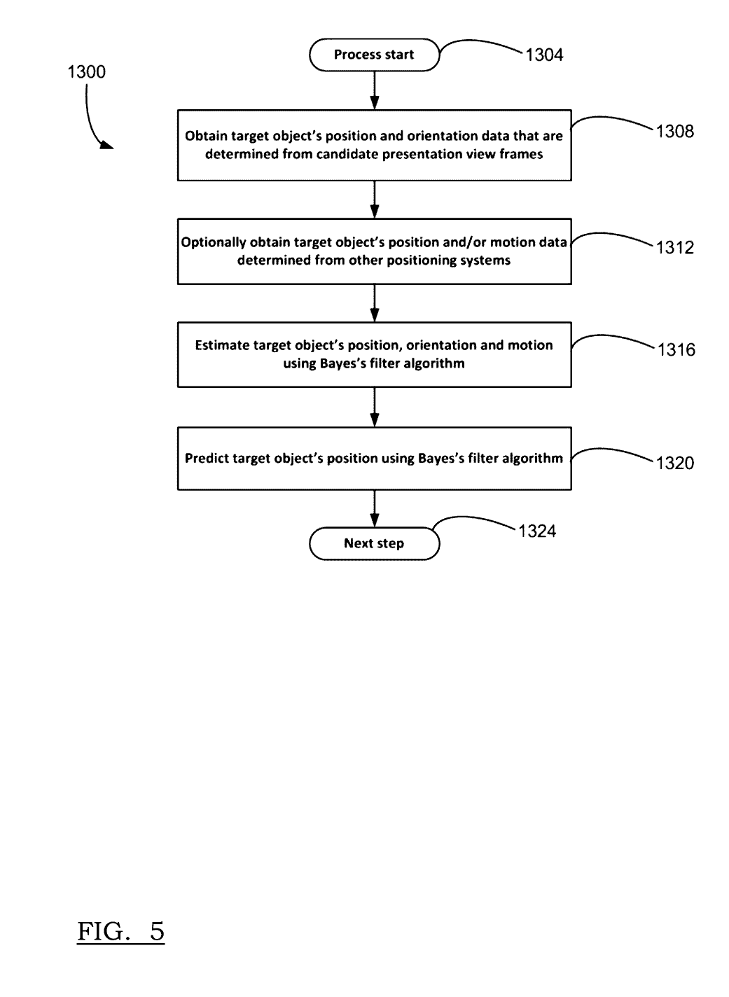

With reference to FIG. 5, a method for target object position and motion estimation is illustrated according to one or more embodiments and is generally referenced by numeral 1300. After the process starts at step 1304, the position and orientation data identified previously are loaded at step 1308. Optionally, position and motion measurement data from other object positioning systems are obtained to assist the state estimation for the target object at step 1312. A Bayesian filter algorithm is employed to process and fusion the target object's position and motion information to estimate the final position, orientation and motion states of the target object at an optimal precision at step 1316. Furthermore, the future states of the target object's position, orientation and motion can also be predicted by the Bayesian filter algorithm at step 1320. The process continues at step 1324 to final presentation view selection process. Non-limiting examples of suitable methodology for target object position fusion and motion estimation is described in United States Patent Application Publication No. 14177772, the disclosures of which are incorporated herein by reference.

In some other embodiments of the view presentation control system 14, the position and motion of the target object are evaluated in camera view frame's pixel coordinate directly instead of mapping it back to the FCS 38. The corresponding camera orientation control is then realized using spatial relationship between the camera view coordinates between each pair of camera systems. A pixel position in one camera view frame can be mapped to corresponding camera view frame position in other camera view frames directly.

Base on the estimated position, orientation and motion of the target object, target object presentation score is evaluated for each of the candidate presentation view frames using prescribed object presentation criteria. The evaluation of the target object presentation score comprises a mixture of criteria. Exemplary criteria include but not limited to: minimal distance from the position of the target object in camera frame to the camera frame center position; maximal ratio between the size of the target object presented on the camera frame to the frame size; minimal error between the orientation of the target object in camera frame to a reference orientation; minimal target object occlusion; and minimal potential switches projected in a future time horizon that is needed to best exhibit the target object. The higher the object presentation score, the better presentation quality the target object is shown in the candidate view frame. Based on the evaluated object presentation score, a set of top ranked candidate view frames are selected as the final presentation view frames.

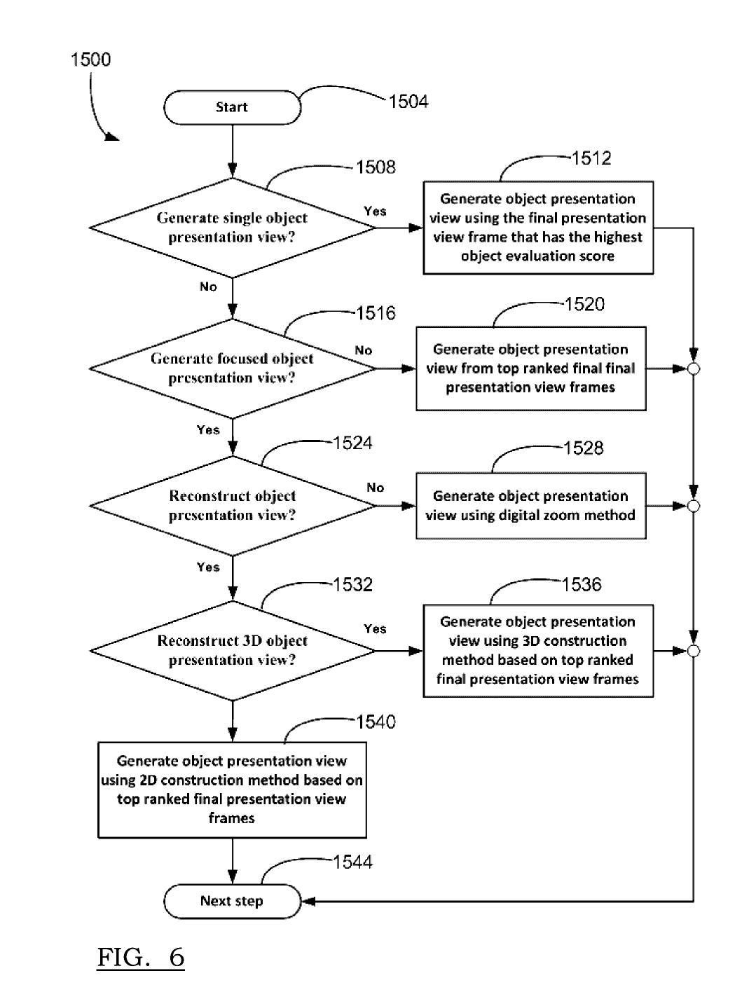

With reference to FIG. 6, a method for object presentation view generation is illustrated according to one or more embodiments and is generally referenced by numeral 1500. After starting at step 1504, the method first checks if only one object presentation view is requested based on system or user's configuration at step 1508. If true, an object presentation view is generated by using the final presentation view frame that has the highest object evaluation score ate step 1512. Otherwise, the method checks if focused object presentation view is request at step 1515. If not, top ranked final presentation view frames are used directly as the object presentation view frames at step 1520. Otherwise, the method next checks if the object presentation view is configured to be generated through reconstruction at step 1524. If not, the object presentation view is generated from the highest ranked final presentation view frame or from other top ranked final presentation view frames using digital zoom method at step 1528. Non-limiting examples of suitable methodology for digital zoom method is described in United States Patent Application Publication No. 14177772, the disclosures of which are incorporated herein by reference. On the other hand, when reconstructed object view is configured, the process is then directed to generate object presentation view either using 2D construction method at step 1540 or using 3D construction method at step 1536 according to the configuration check result at step 1532. Typical 2D construction methods include image stitching. This is a process of combining multiple final presentation view frames with overlapping fields of view to produce a target object focused and high-resolution image. 3D reconstruction from multiple images is the creation of three-dimensional models from a set of final presentation view frames. The key for this process is the relations between multiple views which convey the information that corresponding sets of points must contain some structure and that this structure is related to the poses and the calibration of the camera. Once the object presentation view frame/frames are generated at either step of 1512, 1520, 1528, 1536 or 1544, the method continues to view displaying process at step 1544.

Based on user's configuration and control inputs from the displaying device 18, the view presentation control system 14 processes the camera view frames and sends final object presentation view frames to allowed display devices or internet connected devices for real time viewing. The camera view stream can be recorded into video files. The video records can also be uploaded to internet based data storage and video sharing services.

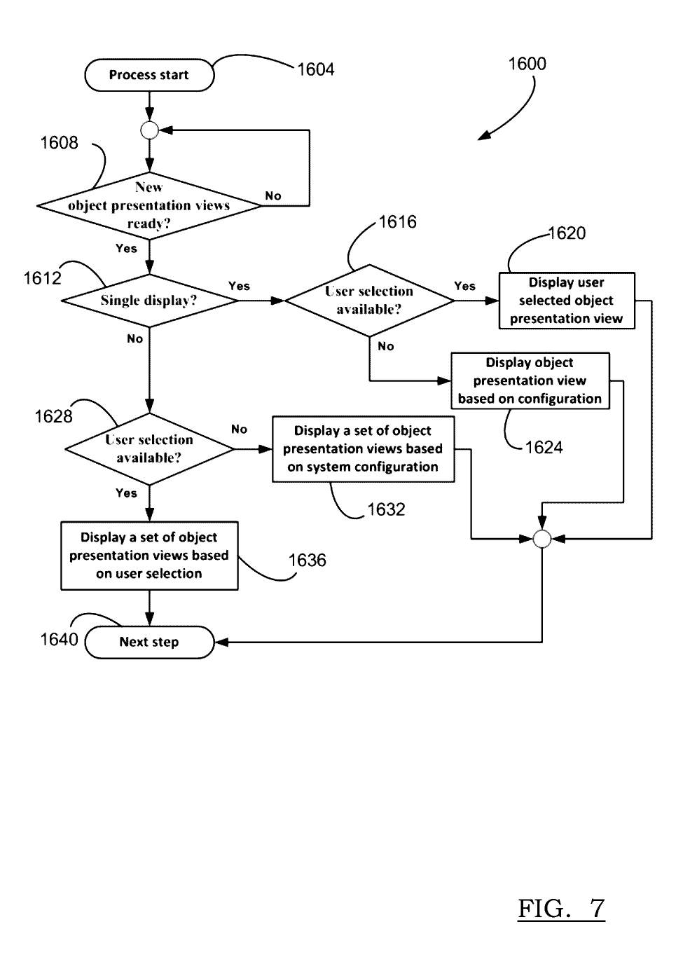

With reference to FIG. 7, a method for controlling object view displaying is illustrated according to one or more embodiments and is generally referenced by numeral 1600. After starting at step 1604, the method first checks if new object presentation views are ready for presentation at step 1608. Once confirmed, the method next goes to step 1612 and checks the system if the present displaying configuration is in single display mode where only one object presentation view is shown on the displaying device. In single display mode, if user's presentation selection is available at step 1616, the presentation function will display user selected object presentation view on the displaying device at step 1620. Otherwise, the object presentation view is displayed on the displaying device using system configured method. On the other hand, if multiple displaying mode is verified at step 1612, the method will display a set of user selected object presentation view on the displaying device at step 1632 if user selection is available at step 1628. Otherwise, the method will display a set of object presentation view based on system configuration at step 1636. After the displaying method is applied in one of the steps of 1620, 1624, 1632 and 1636, the method next continues to other function at step 1640.

As demonstrated by the embodiments described above, the methods and systems of the present invention provide advantages over the prior art by integrating camera systems and displaying devices through control and communication methods and systems. The resulted service system is able to provide applications enabling on-site target object specification and object focused camera view tracking High quality automatic object tracking in camera view can be achieve in a smooth and continuous manner while a target object is performing in an activity field.

While the best mode has been described in detail, those familiar with the art will recognize various alternative designs and embodiments within the scope of the following claims. Additionally, the features of various implementing embodiments may be combined to form further embodiments of the invention. While various embodiments may have been described as providing advantages or being preferred over other embodiments or prior art implementations with respect to one or more desired characteristics, those of ordinary skill in the art will recognize that one or more features or characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are described as less desirable than other embodiments or prior art implementations with respect to one or more characteristics are not outside the scope of the disclosure and may be desirable for particular applications. Additionally, the features of various implementing embodiments may be combined to form further embodiments of the invention.

What is claimed is:

1. A method for providing camera view that automatically tracks and follows target object comprising:
obtaining camera view frames from multiple video streams received from at least one camera system;
preparing candidate presentation view frames based on the position of a target object;
recognizing said target object in at least one of said candidate presentation view frames;
determining the position of said target object;
evaluating a target object presentation score for each of said candidate presentation view frames based on said determined position of said target object;
selecting at least one final presentation view frame from said candidate presentation view frames;
generating at least one object presentation view based on said at least one final presentation view frame; and
displaying said at least one object presentation view on at least one view displaying device.

2. The method of claim 1, wherein said target object comprises at least one object that is specified using at least one of the object initialization features including: object recognized in camera frame; object template; and object position.

3. The method of claim 1, wherein said selecting candidate presentation view frames from said camera view frames comprises verifying that the selected camera view frames have their view covering said target object sufficiently at known position of said target object.

4. The method of claim 1, wherein said position of said target object is determined in a camera view coordinate system that can be mapped to each of said camera view frames.

5. The method of claim 1, wherein said position of said target object is determined in a locally defined field coordinate system using at least one of the following positioning method:
a vision based positioning method;
a WiFi based positioning method;
a cellular network based positioning method;
a navigation satellite based positioning method.

6. The method of claim 1 further comprising determining the state parameters of said target object; and wherein said evaluating a target object presentation score further based on said determined state parameters of said target object.

7. The method of claim 6, wherein said state parameters of said target object comprises:
present motion parameters of said target object;
present orientation parameters of said target object;
estimated future position of said target object;
estimated future motion parameters of said target object;
estimated future orientation parameters of said target object.

8. The method of claim 1, wherein said selecting final presentation view frame is based on said target object presentation score that is evaluated using criteria comprising at least one of:
minimal distance to frame center;
maximal object to frame size ratio;
minimal object orientation error;
minimal object occlusion;
minimal view frame switch occurrence.

9. The method of claim 1, wherein said generating object presentation view comprises at least one of:
generating object presentation view using the final presentation view frame that has the highest object evaluation score;
generating object presentation view from top ranked final presentation view frames;
generating object presentation view using digital zooming method based on the highest ranked final presentation view frame;
generating object presentation view using 2D construction method based on the top ranked final presentation view frames;
generating object presentation view using 3D construction method based on the top ranked final presentation view frames.

10. The method of claim 1, wherein said displaying object presentation view on view displaying device comprises at least one of:
displaying the highest rank final presentation view frame on displaying device;
displaying a number of top rank final presentation view frames on displaying device based on configuration;
displaying a number of top rank final presentation view frames on displaying device based on user selection;
displaying the generated object presentation view on displaying device.

11. A system for providing camera view that automatically tracks and follows target object comprising:
memory, configure to store a program of instructions;
at least one processor operably coupled to said memory and a communication network, configured to execute said program of instructions, wherein when said program of instruction is executed, carries out the steps of:
obtaining camera view frames from multiple video streams received from at least one camera system;
preparing candidate presentation view frames based on the position of a target object;
recognizing said target object in at least one of said candidate presentation view frames;
determining the position of said target object;
evaluating a target object presentation score for each of said candidate presentation view frames based on said determined position of said target object;
selecting at least one final presentation view frame from said candidate presentation view frames;
generating at least one object presentation view based on said at least one final presentation view frame; and
displaying said at least one object presentation view on at least one view displaying device.

12. The system of claim 11, wherein said target object comprises at least one object that is specified using at least one of the object initialization features including: object recognized in camera frame; object template; and object position.

13. The system of claim 11, wherein said selecting candidate presentation view frames from said camera view frames comprises verifying that the selected camera view frames have their view covering said target object sufficiently at known position of said target object.

14. The system of claim 11, wherein said position of said target object is determined in a camera view coordinate system that can be mapped to each of said camera view frames.

15. The system of claim 11, wherein said position of said target object is determined in a locally defined field coordinate system using at least one of the following positioning method:
a vision based positioning system;
a WiFi based positioning system;
a cellular network based positioning system;
a navigation satellite based positioning system.

16. The system of claim 11 further comprising determining the state parameters of said target object; and wherein said evaluating a target object presentation score further based on said determined state parameters of said target object.

17. The system of claim 16, wherein said state parameters of said target object comprises:
present motion parameters of said target object;
present orientation parameters of said target object;
estimated future position of said target object;
estimated future motion parameters of said target object;
estimated future orientation parameters of said target object.

18. The system of claim 11, wherein said selecting final presentation view frame is based on said target object presentation score that is evaluated using criteria comprising at least one of:
minimal distance to frame center;
maximal object to frame size ratio;
minimal object orientation error;
minimal object occlusion;
minimal view frame switch occurrence.

19. The system of claim 11, wherein said program of instruction for generating object presentation view comprises at least one of the step of:
generating object presentation view using the final presentation view frame that has the highest object evaluation score;
generating object presentation view from top ranked final presentation view frames;
generating object presentation view using digital zooming method based on the highest ranked final presentation view frame;
generating object presentation view using 2D construction method based on the top ranked final presentation view frames;
generating object presentation view using 3D construction method based on the top ranked final presentation view frames.

20. The system of claim 11, wherein said program of instruction for displaying object presentation view on view displaying device comprises at least one of the steps of:
displaying the highest rank final presentation view frame on displaying device;
displaying a number of top rank final presentation view frames on displaying device based on configuration;
displaying a number of top rank final presentation view frames on displaying device based on user selection;
displaying the generated object presentation view on displaying device.
